(19) United States
(12) Patent Application Publication
(10) Pub. No.: US 2012/0101838 A1
(43) Pub. Date: Apr. 26, 2012

(54) Systems and Processes for Managing and Supporting Regulatory Submissions in Clinical Trials

(76) Inventors: Helen Mary Lingard, Cary, NC (US); Dawn Michelle Anderson, Raleigh, NC (US); Mary Margaret Barbour, Garner, NC (US); Rae Ellen McCorkle, Clayton, NC (US); Sharon Kinning, Lanark (GB)

(21) Appl. No.: 12/908,616

(22) Filed: Oct. 20, 2010

(51) Int. Cl. G06Q 10/00; G06Q 50/00

(52) U.S. Cl. 705/2

(57) ABSTRACT

Systems and processes for managing and supporting clinical trials and clinical trial operations, more particularly for managing and supporting governmental authority, ethics committee, and/or other regulatory authority notifications and submissions in the context of clinical trials in various countries throughout the world. Such systems and processes leverage the insight that such regulatory authority requirements vary from one country to the next, but that all or essentially all such regulatory authority requirements can be categorized into a limited number of groups as to which a limited number of workflows can be created. Such workflows can be automated and supported with systems and processes according to embodiments of the invention, which can then control sequence of activities to comply with regulations and requirements in the various countries in which a clinical trial occurs.

### BACKGROUND

Clinical trials are conducted to allow safety and efficacy data to be collected for health interventions such as drugs, diagnostics, devices and therapy protocols. These trials take place only after satisfactory information has been gathered on the quality of non-clinical safety, and governmental authority, ethics committee and other regulatory authority approval is granted in the country where the trial is taking place.

Depending on the type of product and the stage of development, investigators enroll volunteers into smaller studies initially, followed by larger scale studies in patients that sometimes compare the new product with currently prescribed treatment. As safety and efficacy data are gathered, the number of patients is typically increased. Clinical trials can range in size from a single center in one country to multi-center trials in multiple countries.

Appropriate governmental authorities and ethics committees for each country where a sponsor wishes to sell the drug or device that is the subject of the trial, review study data, clinical trial protocols and other documents and information submitted to them before allowing the drug or device to proceed to the next phase of trial or to be marketed. Different countries have different regulatory requirements and enforcement abilities.

It has been estimated that 40 percent of all clinical trials currently take place in Asia, Eastern Europe, Central and South America. Each of these countries has its own governmental authority, ethics committee and other regulatory authority regulations for clinical trials. Accordingly, it is common for a trial that involves a particular drug, molecule or device to take place in multiple countries. Adding to the multinational complexity of current clinical trial management issues, entities known as Contract Research Organizations (CRO's) assist in conduct of clinical trial in multiple countries for multiple sponsors.

Previously, governmental authority submission, notification, validation, and approval constraints and regulatory requirements, as well as those of ethics committees, were tracked manually or at least individually. Minimal or no effort was devoted to determine how the requirements of a particular country were similar to and different from requirements in another country in order to group governmental and ethics committee, and other clinical trial related regulatory requirements of various countries into a limited number of groups for streamlining and automating tracking and managing compliance with the regulatory requirements aspects of clinical trials in multiple countries.

### SUMMARY

Accordingly, there is provided a system for managing regulatory submissions in a clinical trial, comprising:

(a) A tracking database comprising task tracking data and status indicators for a plurality of tasks; at least some of the tasks arranged according to a predetermined number of workflows, each workflow corresponding to regulatory requirements in a predetermined group of countries and each workflow comprising a succession of tasks, at least one of the tasks constituting a predicated task for which at least one other task is a predicate task that must be completed as a predicate to completion of the predicated task; and
(b) A processing device including a processor capable of executing instructions to:

(i) Receive input comprising identification of a country and identification of a clinical trial;

(ii) Access the tracking database to select and retrieve at least one workflow corresponding to the country, and for the selected at least one workflow, retrieve a plurality of task tracking data and status indicators for a succession of tasks;

(iii) Present information, on at least one presentation interface, about a plurality of tasks in the selected at least one workflow;

(iv) Receive input and update task tracking data and status indicators about at least some of the plurality of tasks in the selected at least one workflow; and

(v) Permit input for a predicated task only when all required tasks that are predicate to the predicated task have been completed.

There is also provided a system for managing regulatory submissions in a clinical trial, comprising:

(a) A tracking database comprising task tracking data and status indicators for a plurality of tasks;
(i) At least some of the tasks arranged according to a predetermined number of regulatory authority workflows, each regulatory authority workflow corresponding to regulatory requirements in a predetermined group of countries and each regulatory authority workflow comprising a succession of tasks, at least one of the tasks being predicate to a predicated task; and
(ii) At least some of the tasks arranged according to a predetermined number of ethics committee workflows, each ethics committee workflow corresponding to regulatory requirements in a predetermined group of countries and each ethics committee workflow comprising a succession of tasks, at least one of the tasks being predicate to a predicated task;
(b) A document database comprising a plurality of documents, each document related to at least one of the tasks; and
(c) A processing device including a processor capable of executing instructions to:

(i) Receive input comprising identification of a country and identification of a clinical trial;

(ii) Access the tracking database to select and retrieve a selected regulatory authority workflow and a selected ethics committee workflow corresponding to the country, and for each of the selected regulatory authority workflow and the selected ethics committee workflow, retrieve a plurality of task tracking data and status indicators;

(iii) Present information, on at least one presentation interface, about a plurality of tasks in the selected workflow; wherein at least one presentation interface includes a reference to at least one document in the document database that corresponds to at least one of the tasks about which information is presented on the presentation interface;

(iv) Receive input and update task tracking data and status indicators about at least some of the plurality of tasks in the selected workflow;

(v) Permit input for a predicated task only when all required tasks that are predicate to the predicated task have been completed; and

(vi) Prevent input for a predicated task when at least one status indicator for at least one task that is predicate to the predicated task indicates that the predicate task has not been completed.

There is also provided a computer readable storage medium comprising computer executable instructions for managing regulatory submissions in a clinical trial, that when executed by a processor cause the processor to:

(a) Access a tracking database comprising task tracking data and status indicators for a plurality of tasks; at least some of the tasks arranged according to a predetermined number of workflows, each workflow corresponding to regulatory requirements in a predetermined group of countries and each workflow comprising a succession of tasks, at least one of the tasks constituting a predicated task for which at least one other task is a predicate task that must be completed as a predicate to completion of the predicated task;
(b) Receive input comprising identification of a country and identification of a clinical trial;
(c) Select and retrieve from the tracking database at least one workflow corresponding to the country, and for the selected at least one workflow, retrieve a plurality of task tracking data and status indicators for a succession of tasks;
(d) Present information, on at least one presentation interface, about a plurality of tasks in the selected at least one workflow;
(e) Receive input and update task tracking data and status indicators about at least some of the plurality of tasks in the selected at least one workflow; and
(f) Permit input for a predicated task only when all required tasks that are predicate to the predicated task have been completed.

There is also provided a computer readable storage medium comprising computer executable instructions for managing regulatory submissions in a clinical trial, that when executed by a processor cause the processor to:

(a) Access a tracking database comprising task tracking data and status indicators for a plurality of tasks;
(i) At least some of the tasks arranged according to a predetermined number of regulatory authority workflows, each regulatory authority workflow corresponding to regulatory requirements in a predetermined group of countries and each regulatory authority workflow comprising a succession of tasks, at least one of the tasks being predicate to at least one predicated task; and
(ii) At least some of the tasks arranged according to a predetermined number of ethics committee workflows, each ethics committee workflow corresponding to regulatory requirements in a predetermined group of countries and each ethics committee workflow comprising a succession of tasks, at least one of the tasks being predicate to at least one predicated task;
(b) Access a document database comprising a plurality of documents, each document related to at least one of the tasks; and
(c) Receive input comprising identification of a country and identification of a clinical trial;
(d) Select and retrieve from the tracking database a selected regulatory authority workflow and a selected ethics committee workflow corresponding to the country, and for each of the selected regulatory authority workflow and the selected ethics committee workflow, retrieve a plurality of task tracking data and status indicators;
(e) Present information, on at least one presentation interface, about a plurality of tasks in the selected workflow; wherein at least one presentation interface includes a reference to at least one document in the document database that corresponds to at least one of the tasks about which information is presented on the presentation interface;
(f) Receive input and update task tracking data and status indicators about at least some of the plurality of tasks in the selected workflow;
(g) Permit input for a predicated task all required tasks that are predicate to the predicated task have been completed; and
(h) Prevent input for a predicated task when at least one status indicator for at least one task that is predicate to the predicated task indicates that the predicate task has not been completed.

According to some embodiments, the system comprises a document database, the document database comprising a plurality of documents, each document related to at least one of the tasks.

According to some embodiments, at least one of the presentation interfaces includes a reference to at least one document in the document database that corresponds to at least one of the tasks about which information is presented on the presentation interface.

According to some embodiments, the processor is capable of executing instructions to prevent input for a predicated task when at least one status indicator for at least one task that is predicate to the predicated task indicates that the predicate task has not been completed.

According to some embodiments, the processor is capable of executing instructions to present a prompt for at least one predicate task when input for the predicated task is prevented.

According to some embodiments, the tracking database also includes due dates and completion dates for at least some of the tasks.

According to some embodiments, the processor is capable of executing instructions to present a prompt for at least one due date.

According to some embodiments, the tracking database comprises task tracking data and status indicators for tasks arranged according to a predetermined number of regulatory authority workflows, each regulatory authority workflow corresponding to regulatory requirements in a predetermined group of countries.

According to some embodiments, the tracking database comprises task tracking data and status indicators for tasks arranged according to a predetermined number of ethics committee workflows, each ethics committee workflow corresponding to regulatory requirements in a predetermined group of countries.

According to some embodiments, the tracking database comprises task tracking data and status indicators for tasks arranged according to a predetermined number of regulatory authority workflows, each regulatory authority workflow corresponding to regulatory requirements in a predetermined group of countries, and task tracking data and status indicators for tasks arranged according to a predetermined number of ethics committee workflows, each ethics committee workflow corresponding to regulatory requirements in a predetermined group of countries.

According to some embodiments, the predetermined number of workflows comprise a first workflow that includes submission and notification tasks, a second workflow that includes submission, notification, validation, question response and condition fulfillment tasks; a third workflow that includes notification tasks, and a fourth workflow that includes submission, notification and question response tasks.

According to some embodiments, the predetermined number of regulatory authority workflows and the predetermined number of ethics committee workflows each comprise a first workflow that includes submission and notification tasks, a second workflow that includes submission, notification, validation, question response and condition fulfillment tasks; a third workflow that includes notification tasks, and a fourth workflow that includes submission, notification and question response tasks.

Further features and advantages of at least some of the embodiments, as well as the structure and operation of various embodiments, are described in detail below with reference to the accompanying drawings.

### BRIEF DESCRIPTION OF THE DRAWINGS

FIG. 1 is a process flow diagram that focuses on regulatory submission aspects of clinical trial conduct and management.

FIG. 2 is a functional block diagram of a system suitable for use in accordance with an embodiment of the invention.

FIG. 3 is a workflow diagram of a first central ethics committee process workflow according to an embodiment of the invention.

FIG. 4 is a workflow diagram of a second central ethics committee process workflow according to an embodiment of the invention.

FIG. 5 is a workflow diagram of a third central ethics committee process workflow according to an embodiment of the invention.

FIG. 6 is a workflow diagram of a fourth central ethics committee process workflow according to an embodiment of the invention.

FIG. 7 is a workflow diagram of a first regulatory authority process workflow according to an embodiment of the invention.

FIG. 8 is a workflow diagram of a second regulatory authority process workflow according to an embodiment of the invention.

FIG. 9 is a workflow diagram of a third regulatory authority process workflow according to an embodiment of the invention.

FIG. 10 is a workflow diagram of a fourth regulatory authority process workflow according to an embodiment of the invention.

FIGS. 11-21 are screen faces presented by a system in accordance with an embodiment of the invention.

### DETAILED DESCRIPTION

### Clinical Trial Management—Regulatory Submissions High Level Workflow

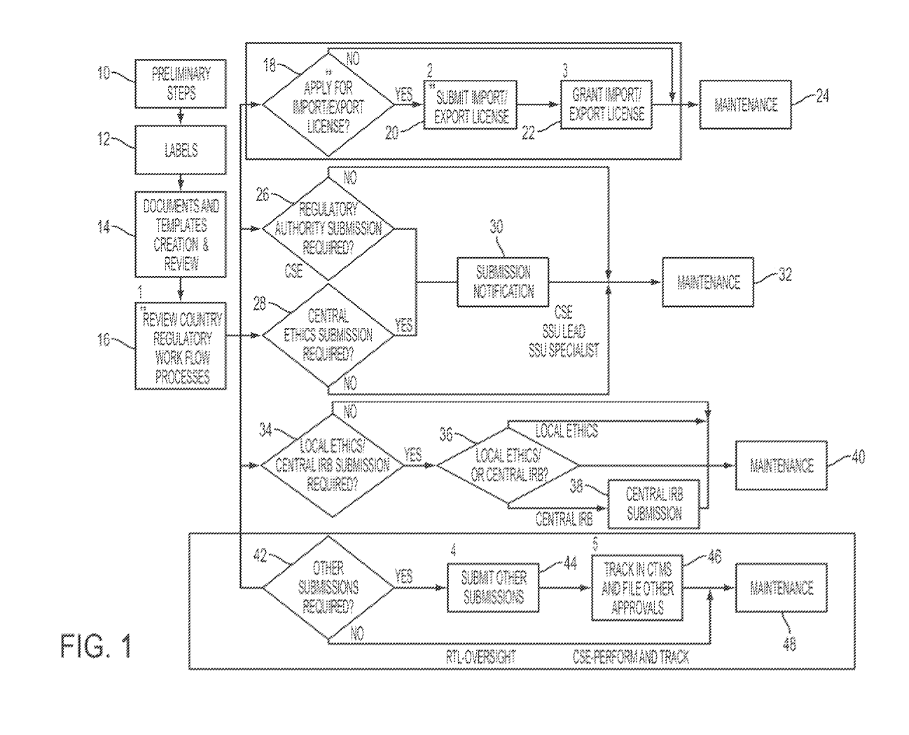

FIG. 1 is a flow diagram showing high level workflow for a clinical trial management system according to an embodiment of the invention. Numeral 10 denotes preliminary steps that may be tracked by such a system. Those may include, for example, review of regulatory and site start-up plans, assignment of team members, setting of milestones and methods, creation of document templates, dealing with certificates of insurance, collection, development and filing of documents, compliance with good management practices, and other steps that are conducted in preliminary stages of conduct and management of clinical trials. Block 12 refers to preparation of labels, including, for example creating and reviewing draft label text, ensuring compliance with relevant countries' requirements, and other steps associated with preparing and approval of labels. Any or all of these steps may be subject to supervision by a clinical lead person (“Clinical Lead”), a regulatory team lead person (“RTL”) and/or other relevant personnel. Block 14 refers to creation of relevant documents and templates, including creation of drafts from templates, regulatory team leader review, sending, collecting and reviewing site specific documents, and development and approval of informed consent documents as well as translation of relevant documents to be used in clinical trial. At this point, review and submission of country regulatory workflow processes as denoted in block 16 may occur. Such steps can be conducted and subject to review by a country submission expert (“CSE”), a site start-up lead (“SSU lead”), a site start-up specialist (“SSU specialist”), and/or an RTL. Other steps that follow in the context of Regulatory Authority and/or Ethics Submissions can include such involvement as well.

In Block 18, a determination is made as to whether application for Import/Export License is necessary. If no, the workflow moves to Block 24 entitled “Maintenance,” which refers to ongoing additional efforts that may be required in connection with import/export licenses if any. If yes, the workflow moves to block 20 where applications for import/export licenses are prepared and submitted. These can be done with involvement of the CSE with RTL oversight as appropriate. The workflow then moves to block 22 where import/export licenses are granted, and then to block 24 entitled “Maintenance” where ongoing efforts are undertaken that may be required in connection with import/export licenses if any.

A second group of activities that occurs in the context of regulatory submissions as shown in FIG. 1 is submissions to governmental or other regulatory authorities (“RA”) and central ethics committees (“CEC”) in various countries. For purposes of this document, governmental authorities, ethics committees and other authorities or committees which may have cognizance over or regulations or requirements that relate to clinical trials or conduct of clinical trials are sometimes referred to as “regulatory authorities” and submissions to such authorities or committees are referred to as “regulatory submissions.”

In block 26, a determination is made whether submissions to RAs are required and if so those are undertaken in the context of Submission/Notification processes in block 30. After those measures are taken, ongoing additional efforts that may be required in connection with RA submissions occur in the context of block 32 entitled “Maintenance.” If no RA submissions are required, the next steps are those in accordance with block 32.

Decision block 28 is the determination whether CEC submissions are required. If yes, the Submission/Notification process occurs in the context of block 30 and additional ongoing efforts may occur in the context of block 32. If no, the Submissions Notification steps are omitted and the next steps are the maintenance steps in accordance with block 32.

The system can also track steps related to local ethics or central IRB submissions at decision blocks 34 and 36, and blocks 38 and 40.

Decision block 42 involves whether other submissions are required. If yes, they are prepared and submitted in the context of block 44 and tracked in the context of block 46. If not, the flow proceeds directly to block 48 where any further management and coordination occurs.

### Illustrative System Implementation

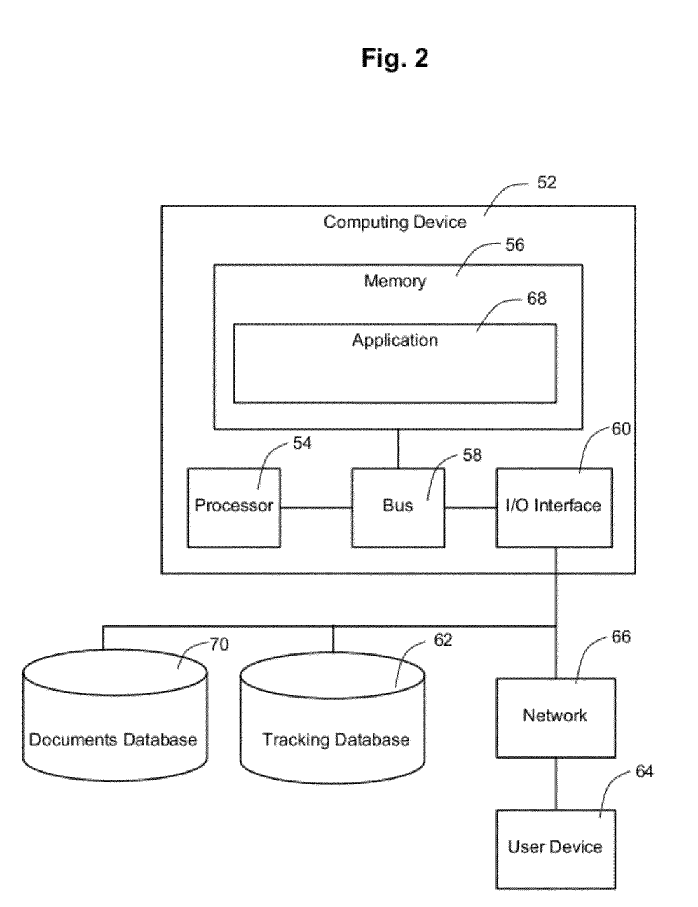

FIG. 2 shows a system that is capable of managing and running workflow, including regulatory submissions workflow such as in FIG. 1 and other figures in this document, in clinical trials. Other embodiments may be utilized. The system includes a computing device 52 having a processor 54 that can execute code that comprises computer executable instructions, stored on a computer-readable medium, such as a memory 56, to cause the computing device 52 to assist in management and operation of clinical trials with process flow and interfaces such as reflected in FIG. 1 and other figures in this document. The computing device 52 may be any device that can process data and execute code that includes a set of instructions to perform actions. Examples of the computing device 52 include a database server, desktop personal computer, a laptop personal computer, a server device, a handheld computing device, and a mobile device.

Examples of the processor 54 include a microprocessor, an application-specific integrated circuit (ASIC), a state machine, or other suitable processor. The processor 54 may include one processor or any number of processors. The processor 54 can access code stored in the memory 56 via a bus 58 which may be any desirable circuit or set of circuits or networks, including physical or air interface. The memory 56 may be any transitory or non-transitory computer-readable medium capable of tangibly embodying code. The memory 56 can include electronic, magnetic, or optical devices, capable of providing processor 54 with executable code or instructions. Examples of the memory 56 include random access memory (RAM), read-only memory (ROM), a floppy disk, compact disc, digital video device, magnetic disk, an ASIC, a configured processor, or other storage device. The bus 58 may be any device capable of transferring data between components of the computing device 52. The bus 58 can include one device or multiple devices.

The computing device 52 can share data with additional components through an input/output (I/O) interface 60. The I/O interface 60 can include a USB port, an Ethernet port, a serial bus interface, a parallel bus interface, a wireless connection interface, or any suitable interface capable of allowing data transfers between the computing device and another component. The additional components can include a tracking database 62, which can be an implementation of Siebel CRM database software and platforms, more particularly, of Siebel's Clinical Trial Management System, a documents database 70, and a user device 64 communicating over a network 66. In other embodiments the computing device 52 includes the tracking database 62 and/or documents database 70, or communicates with either or both such databases over network 66 or other suitable connectivity. The user device 64 can include a second computing device, such as a laptop or personal computer that is capable of processing commands to output a user interface to a display. The network 66 can include the internet, an intranet, wide area network (WAN), local area network (LAN), virtual private network (VPN), or any suitable communications network that allows computing device 52 to communicate with other components.

Instructions can be stored in the memory 56 as executable code. The instructions can include processor-specific instructions generated by a compiler and/or an interpreter from code written in any suitable computer-programming language, such as C, C++, C#, Visual Basic, Java, Python, Peri, JavaScript, and ActionScript. The instructions can include a clinical trial management application 68 that, when executed by the processor 54, can cause the computing device 52 to support clinical trial management activities by participation at whatever desired level in carrying out process flow as shown in FIG. 1 and other figures in this document, and other desired workflow, tracking, data correlation and management functions, and any other tasks included in or associated with management of clinical trails.

This exemplary system configuration is provided to illustrate potential configurations that can be used to implement certain embodiments. Other configurations may of course be utilized.

### Central Ethics Committee Submissions Workflows

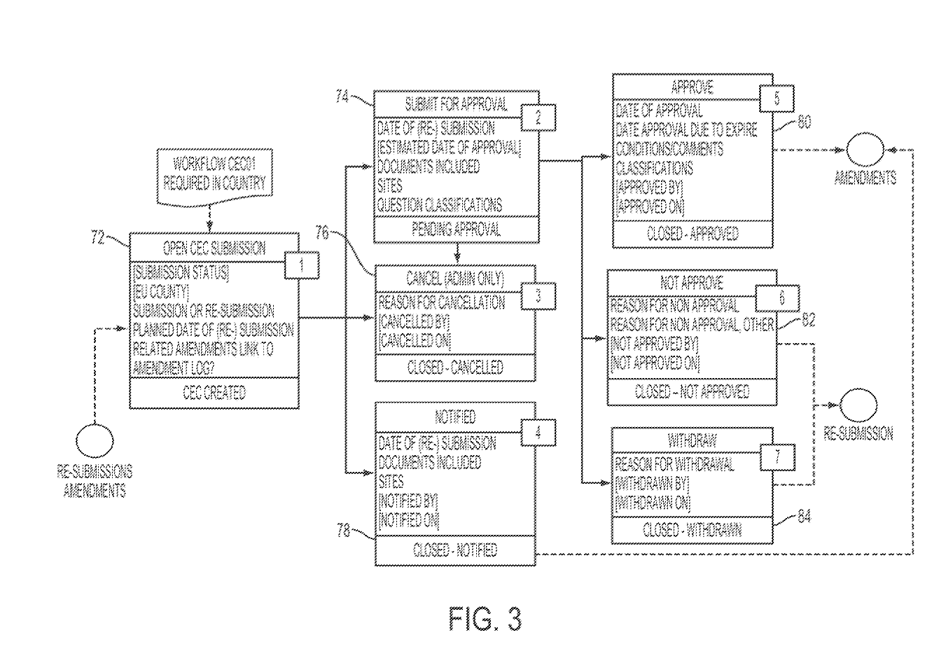

FIGS. 3-6 show four workflows in connection with submissions to CEC's in various countries. These workflows may be carried out using functionality as shown in FIG. 2, and they can fit generally in the context of block 30 in the workflow shown in FIG. 1. In accordance with certain embodiments, it has been recognized that regulations promulgated by CEC's in various countries around the world in which clinical trials are conducted, and steps and sequences in how those regulations are complied with, differ from one country to the next but share some characteristics in common. The common characteristics have been found to be sufficient to allow for CEC submissions in essentially all countries to be grouped currently into four major workflows, though more or fewer workflows may be developed and used. The four workflows are shown in FIGS. 3-6.

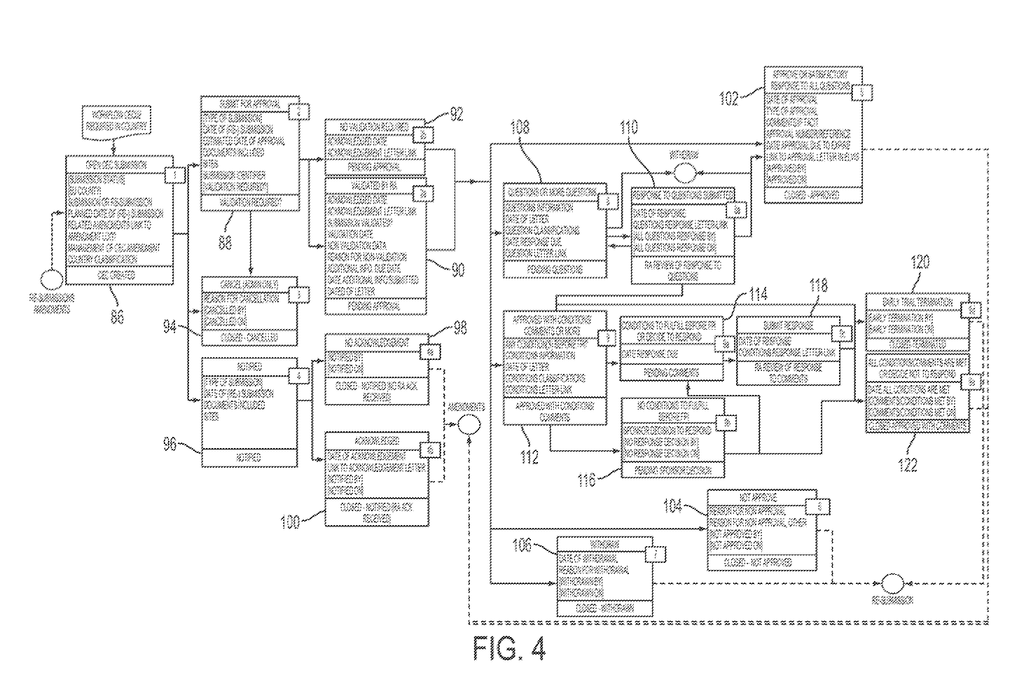

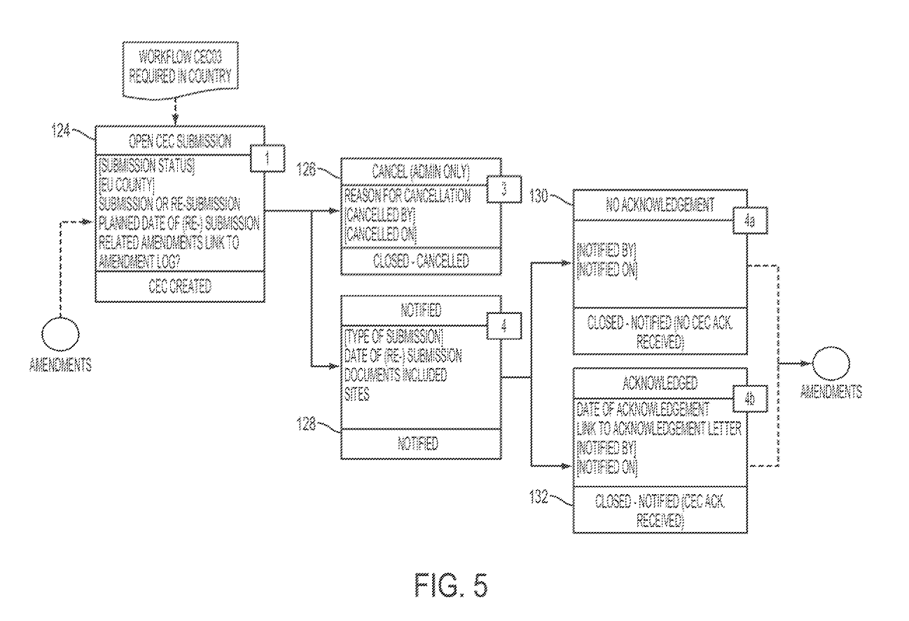

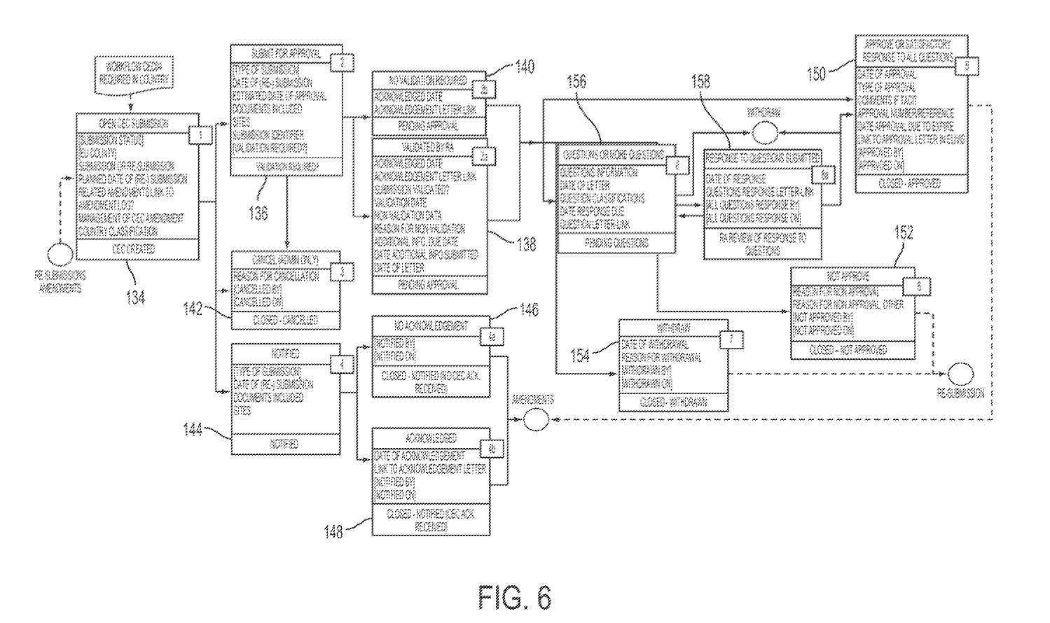

FIG. 3 shows a workflow where CEC requirements involve submissions to the committee and/or notification to the committee. FIG. 4 shows a workflow which involves submissions and/or notification to the committee, and if submissions are required, additional steps involving validation of the submissions, answering questions from the CEC and dealing with conditions imposed by the CEC in connection with the submissions. The workflow shown in FIG. 5 is for countries which emphasize notification but not submission for approval. The workflow in FIG. 6 is similar to the workflow in FIG. 4, but where there is no requirement to deal with conditions imposed after the submissions occur.

FIG. 3 shows a workflow entitled “CEC01” that corresponds to countries where CEC's require submissions and/or notifications. The workflow proceeds in block 72 where preliminary efforts are undertaken in connection with the process. In block 74, tracking of the submission occurs including tracking data for submission, estimated date of approval, documents included, identification of sites and other information. Cancellation of a submission is permitted in block 76 of the workflow. In countries where notification is required, tracking of such notification occurs in block 78, including date of submission, documents, sites, identification of who was notified and by whom on what date, and other matters. In block 80, approval of submissions is tracked including date of approval, conditions or comments and other matters. If non-approval occurs, block 82 of the workflow involves tracking the non-approval including reasons, identification of who did not approve, the date of non-approval and closure of the matter. Block 84 of the workflow involves withdrawal of the submission including tracking reasons, identification of who withdrew and the date of withdrawal of the submission. Amendments and resubmissions can occur as shown in the figure, whereupon tracking starts once again at block 72.

FIG. 4 shows a workflow entitled “CEC 02” for countries where CEC's require submissions and/or notifications as well as further requirements. The workflow proceeds in block 86 where preliminary efforts are undertaken in connection with the process. In block 88, tracking of the submission occurs including tracking data for submission, estimated date of approval, documents included, sites and other information. Cancellation of the submission is tracked in block 94 of the workflow. In countries where notification is required, tracking of such notification occurs including date of submission, documents, sites, who was notified by whom on what date and other matters in block 96. Block 90 of the workflow relates to validation by relevant authorities and tracking of such validation. Block 92 of the workflow reflects tracking in countries where no validation is required. Where notification occurs as in block 96, block 98 reflects tracking of information where no acknowledgement occurs and block 100 relates to situations where acknowledgement does occur. Dates, identity of the notifier, and other information is tracked.

Proceeding from the validation step, block 102 reflects approval of the submission, where no questions or conditions are interposed by the CEC. Block 102 allows tracking of approval information including date of approval, type, comments, approval date and links to documents in the document database 70. In situations where questions are asked by the CEC, block 108 addresses tracking of such questions including tracking of information, date of correspondence, classifications, response dates, and references (such as identification or links) to the document database 70 for relevant documents. Block 110 addresses tracking of responses to such questions. There can be interaction between steps in block 108 and block 110, and both can lead to a decision to withdraw the submission. If the questions are answered appropriately, the process flow leads to block 102 where approval of the submission is tracked.

Block 112 relates to situations where conditions are imposed by the CEC in connection with approval of the submission or otherwise. Block 112 allows tracking of information about such conditions including information, correspondence dates, classifications and links to the document database 70 for relevant documents. Block 114 addresses tracking of information about responses to conditions that are imposed, and block 118 addresses tracking of information about the actual response and links to relevant documents in the document database 70. Block 116 relates to situations where no conditions need to be fulfilled. In block 120, information is tracked about trial termination, and in block 122, information is tracked about fulfillment of conditions.

FIG. 5 shows a workflow entitled “CEC 03” required for countries where CEC's require notifications but not submissions. The workflow proceeds in block 124 where preliminary efforts are undertaken in connection with the process. Cancellation of notification can be tracked according to block 126 including reasons, persons and cancellation dates. If notification occurs, block 128 allows tracking of the notification including type of submission, date of resubmission, documents and relevant sites. In block 130, situations where no acknowledgement of the notification is received may be tracked. Where acknowledgment occurs, block 132 allows for tracking of such acknowledgement including the date of acknowledgement, line in the document database to acknowledgement letter, relevant individuals and dates.

FIG. 6 shows a workflow entitled “CEC 04” for countries where CEC's require submissions and/or notifications, and where validation of submissions and questions in connection with approval may be involved. The workflow proceeds in block 134 where preliminary efforts are undertaken in connection with the process. In block 136, tracking of the submission occurs including tracking data for submission, estimated date of approval, documents included, sites and other information. Cancellation of the submission is tracked in block 142 of the workflow. In countries where notification is required, tracking of such notification occurs including date of submission, documents, sites, who was notified by whom on what date and other matters in block 144. Block 138 of the workflow relates to validation by relevant authorities and tracking of such validation. Block 140 of the workflow reflects tracking in countries where no validation is required. Where notification occurs as in block 144, block 146 reflects tracking of information where no acknowledgement occurs and block 148 relates to situations where acknowledgement does occur. Dates, identity of the notifier, and other information is tracked.

Proceeding from the validation step, block 150 reflects approval, where no questions are interposed by the CEC. Block 150 addresses tracking of approval information including date of approval, type, comments, approval date and links to documents in the document database 70. In situations where questions are asked by the CEC, block 156 addresses tracking of such questions including tracking of information, date of correspondence, classifications, response dates, and links to the document database 70 for relevant documents. Block 158 addresses tracking of responses to such questions. There can be interaction between steps in block 156 and block 158, and both can lead to a decision to withdraw the submission. If the questions are answered appropriately, the process flow leads to block 134 where approval of the submission is tracked.

### Governmental and/or Other Regulatory Authority Submissions Workflows

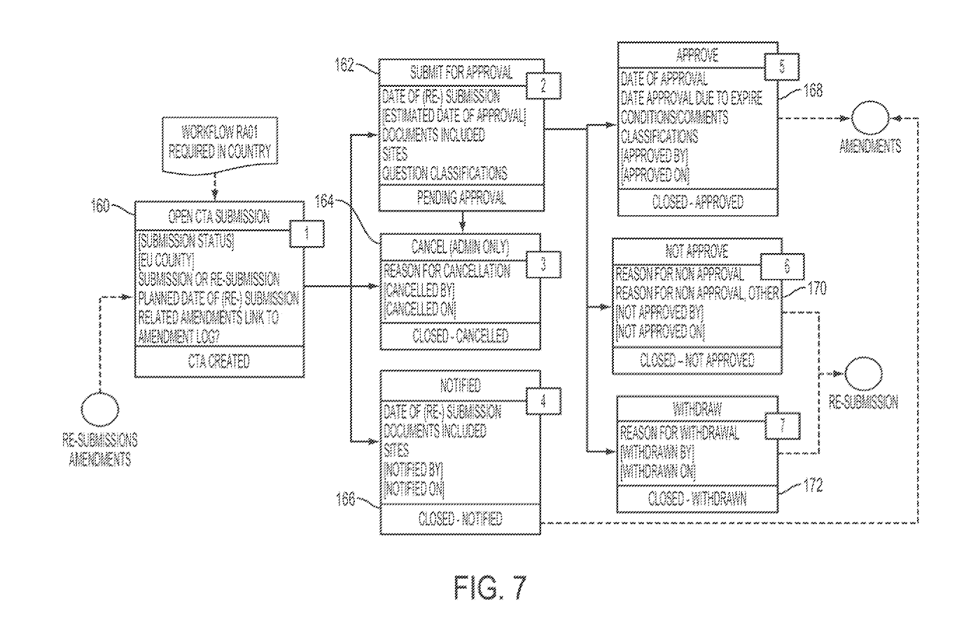

FIGS. 7-10 show four workflows in connection with submissions to RA's in various countries. These workflows may be carried out using functionality as shown in FIG. 2, and they can fit generally in the context of block 30 in the workflow shown in FIG. 1. In accordance with certain embodiments, it has been recognized that regulations promulgated by regulatory authorities in various countries around the world in which clinical trials are conducted, and steps and sequences in how those regulations are complied with, differ from one country to the next but share some characteristics in common. The common characteristics have been found to be sufficient to allow for RA submissions in essentially all countries to be grouped currently into four major workflows, though more or fewer workflows may be developed and used. The four workflows are shown in FIGS. 7-10.

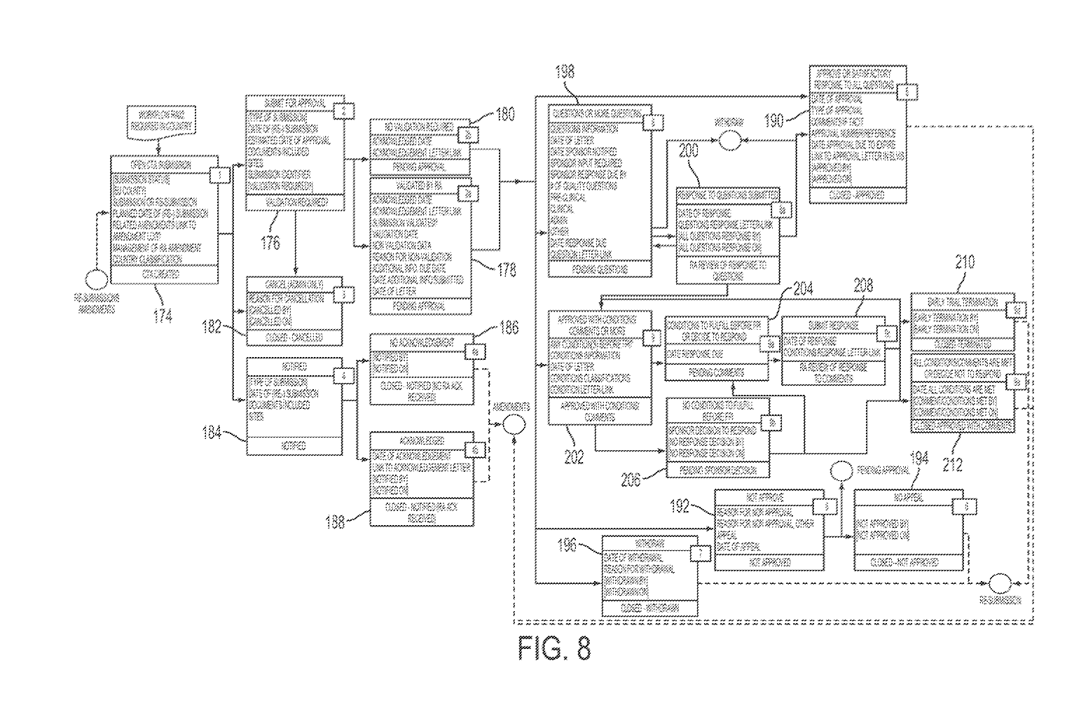

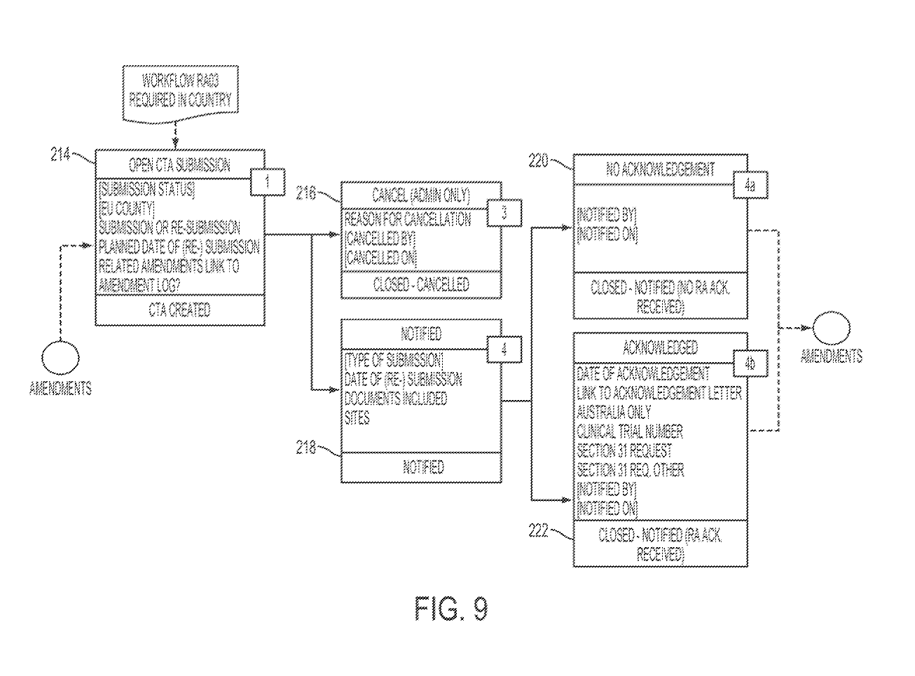

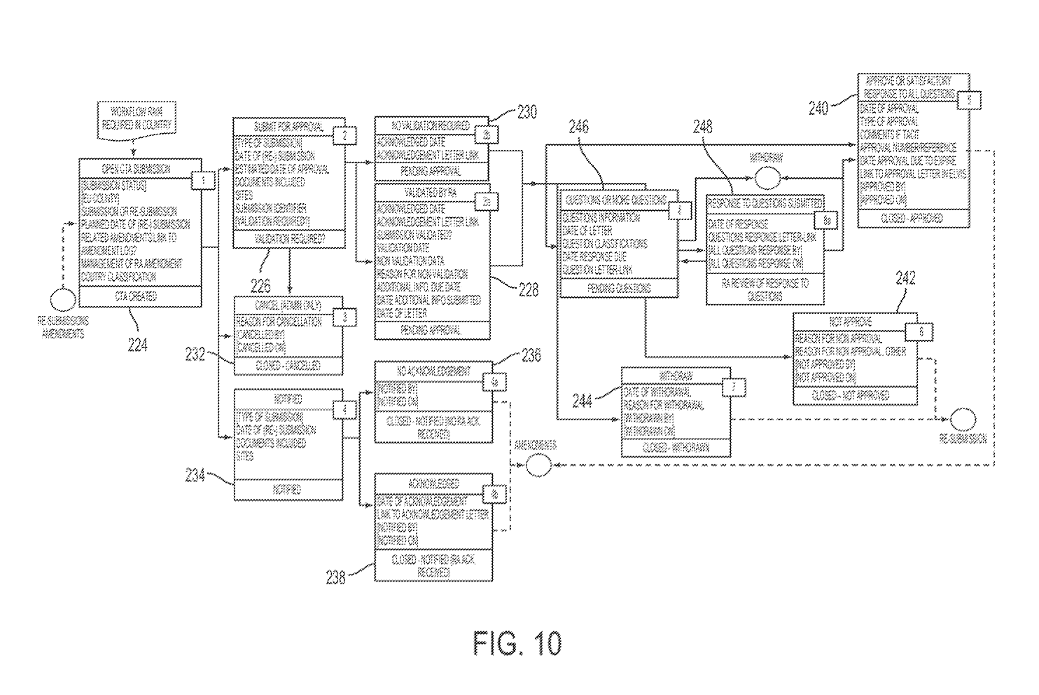

FIG. 7 shows a workflow where RA requirements involve submissions to the RA and/or notification to the RA. FIG. 8 shows a workflow which involves submissions and/or notification to the RA, and if submissions are required, additional steps involving validation of the submissions, answering questions from the RA and dealing with conditions imposed by the RA in connection with the submissions. The workflow shown in FIG. 9 is for countries which emphasize notification but not submission for approval. The workflow in FIG. 10 is similar to the workflow in FIG. 8, but where there is no requirement to deal with conditions imposed after the submissions occur.

FIG. 7 shows a workflow entitled “RA01” that corresponds to countries where RA's require submissions and/or notifications. The workflow proceeds in block 160 where preliminary efforts are undertaken in connection with the process. In block 162, tracking of the submission occurs including tracking data for submission, estimated date of approval, documents included, identification of sites and other information. Cancellation of a submission is permitted in block 164 of the workflow. In countries where notification is required, tracking of such notification occurs in block 166, including date of submission, documents, sites, identification of who was notified and by whom on what date, and other matters. In block 168, approval of submissions is tracked including date of approval, conditions or comments and other matters. If non-approval occurs, block 170 of the workflow involves tracking the non-approval including reasons, identification of who did not approve, the date of non-approval and closure of the matter. Block 172 of the workflow involves withdrawal of the submission including tracking reasons, who withdrew and the date of withdrawal of the submission. Amendments and resubmissions can occur as shown in the figure, whereupon tracking starts once again at block 160.

FIG. 8 shows a workflow entitled “RA 02” for countries where RA's require submissions and/or notifications as well as further requirements. The workflow proceeds in block 174 where preliminary efforts are undertaken in connection with the process. In block 176, tracking of the submission occurs including tracking data for submission, estimated date of approval, documents included, sites and other information. Cancellation of the submission is tracked in block 182 of the workflow. In countries where notification is required, tracking of such notification occurs including date of submission, documents, sites, who was notified by whom on what date and other matters in block 184. Block 178 of the workflow relates to validation by relevant authorities and tracking of such validation. Block 180 of the workflow reflects tracking in countries where no validation is required. Where notification occurs as in block 184, block 186 reflects tracking of information where no acknowledgement occurs and block 188 relates to situations where acknowledgement does occur. Dates, identity of the notifier, and other information is tracked.

Proceeding from the validation step, block 190 reflects approval of the submission, where no questions or conditions are interposed by the RA. Block 190 allows tracking of approval information including date of approval, type, comments, approval date and links to documents in the document database 70. In situations where questions are asked by the RA, block 198 addresses tracking of such questions including tracking of information, date of correspondence, classifications, response dates, and links to the document database 70 for relevant documents. Block 200 addresses tracking of responses to such questions. There can be interaction between steps in block 198 and block 200, and both can lead to a decision to withdraw the submission. If the questions are answered appropriately, the process flow leads to block 190 where approval of the submission is tracked.

Block 202 relates to situations where conditions are imposed by the RA in connection with approval of the submission or otherwise. Block 204 allows tracking of information about such conditions including information, correspondence dates, classifications and links to the document database 70 for relevant documents. Block 206 addresses tracking of information about responses to conditions that are imposed, and block 208 addresses tracking of information about the actual response and links to relevant documents in the document database 70. Block 206 relates to situations where no conditions need to be fulfilled. In block 210, information is tracked about trial termination, and in block 212, information is tracked about fulfillment of conditions.

FIG. 9 shows a workflow entitled “RA 03” required for countries where RA's require notifications but not submissions. The workflow proceeds in block 214 where preliminary efforts are undertaken in connection with the process. Cancellation of notification can be tracked according to block 216 including reasons, persons and cancellation dates. If notification occurs, block 218 allows tracking of the notification including type of submission, date of resubmission, documents and relevant sites. In block 220, situations where no acknowledgement of the notification is received may be tracked. Where acknowledgment occurs, block 222 allows for tracking of such acknowledgement including the date of acknowledgement, line in the document database to acknowledgement letter, relevant individuals and dates.

FIG. 6 shows a workflow entitled “RA 04” for countries where RA's require submissions and/or notifications, and where validation of submissions and questions in connection with approval may be involved. The workflow proceeds in block 224 where preliminary efforts are undertaken in connection with the process. In block 226, tracking of the submission occurs including tracking data for submission, estimated date of approval, documents included, sites and other information. Cancellation of the submission is tracked in block 232 of the workflow. In countries where notification is required, tracking of such notification occurs including date of submission, documents, sites, who was notified by whom on what date and other matters in block 234. Block 228 of the workflow relates to validation by relevant authorities and tracking of such validation. Block 230 of the workflow reflects tracking in countries where no validation is required. Where notification occurs as in block 234, block 236 reflects tracking of information where no acknowledgement occurs and block 238 relates to situations where acknowledgement does occur. Dates, identity of the notifier, and other information is tracked.

Proceeding from the validation step, block 240 reflects approval of the submission, where no questions are interposed by the RA. Block 240 addresses tracking of approval information including date of approval, type, comments, approval date and links to documents in the document database 70. In situations where questions are asked by the RA, block 246 addresses tracking of such questions including tracking of information, date of correspondence, classifications, response dates, and links to the document database 70 for relevant documents. Block 248 addresses tracking of responses to such questions. There can be interaction between steps in block 246 and block 248, and both can lead to a decision to withdraw the submission. If the questions are answered appropriately, the process flow leads to block 240 where approval of the submission is tracked. Withdrawal of a submission can be tracked in block 244, and failure to approve pending questions imposed by an RA can be tracked in block 246. Either or both withdrawal and failure to approve, as shown in blocks 244 and 246, respectively, can lead to resubmission and thus back to block 224 as shown in the figure.

### Tracking

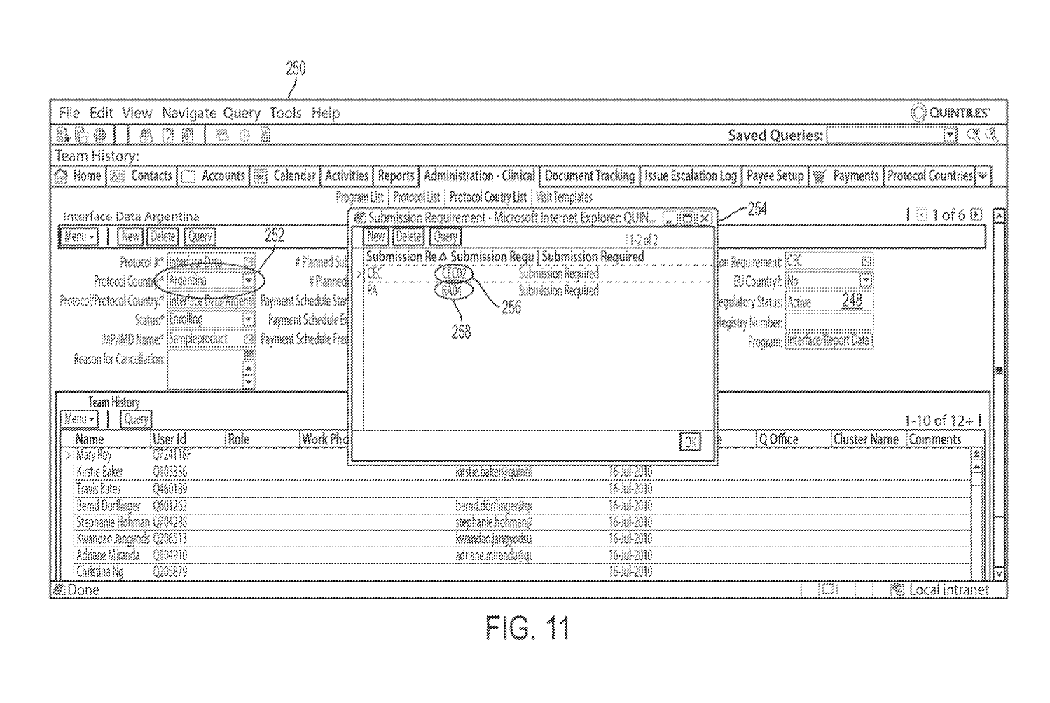

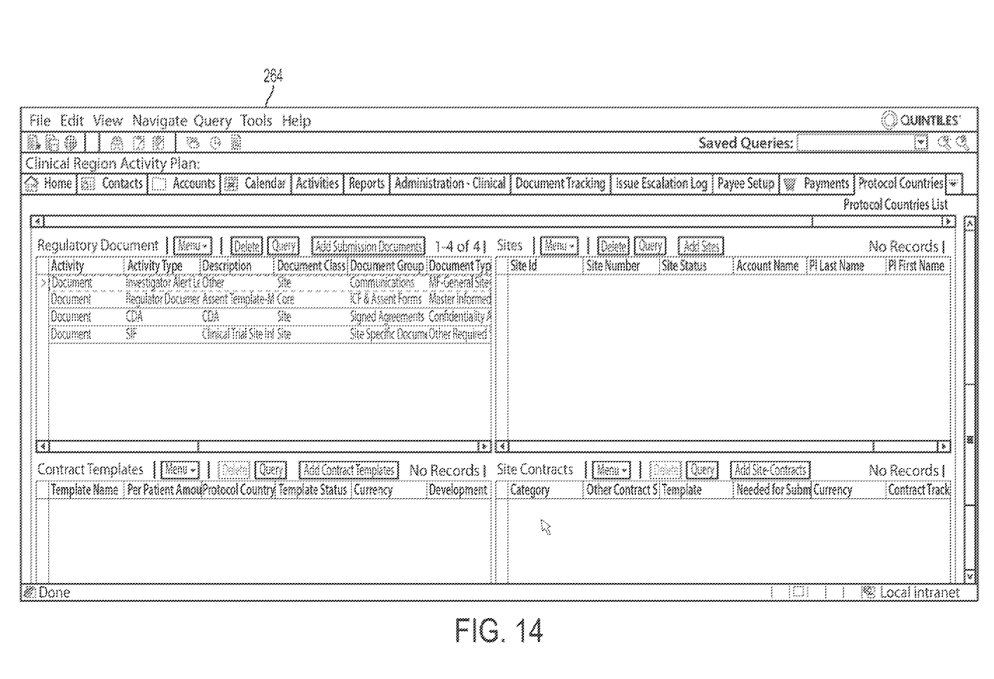

FIGS. 11-21 show clinical trial management screen faces supported in accordance with an embodiment, using a system such as shown in FIG. 2, and workflows such as shown in FIGS. 3-10, in the context of higher level workflow such as shown in FIG. 1.

FIG. 11 shows a country screen face 250 for tracking and managing clinical trial activities occurring in a particular country, in this case Argentina. Screen face 250 can be considered to support workflow in blocks 26 and 28 of FIG. 1. Screen face 250 indicates that Argentina is selected as the country in field 252. When Argentina is selected, a popup 254 appears as supported by an applet (such as a JAVA applet) or otherwise that automatically shows which CEC workflow and which RA workflow are relevant for Argentina. In this case, CEC 02 workflow is denoted by numeral 256, which is the workflow shown in FIG. 4. RA04 workflow is denoted by numeral 258 as the RA workflow for Argentina, which is the workflow shown in FIG. 10. Screen face 250 also presents other information about the clinical trial activities for this particular trial in Argentina, and other pop-ups can appear when other fields are invoked and input entered.

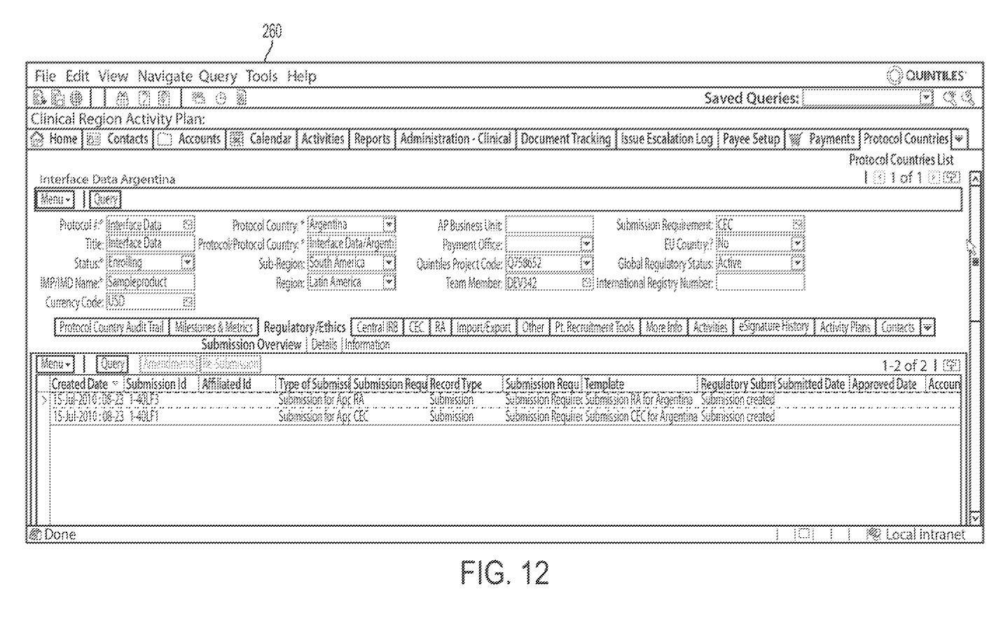

A submission overview screen face 260 is shown for the Argentina clinical trial management and tracking activities in FIG. 12. There, it can be seen that an RA submission was created on Jul. 15, 2010 and a CEC submission was created on the same date.

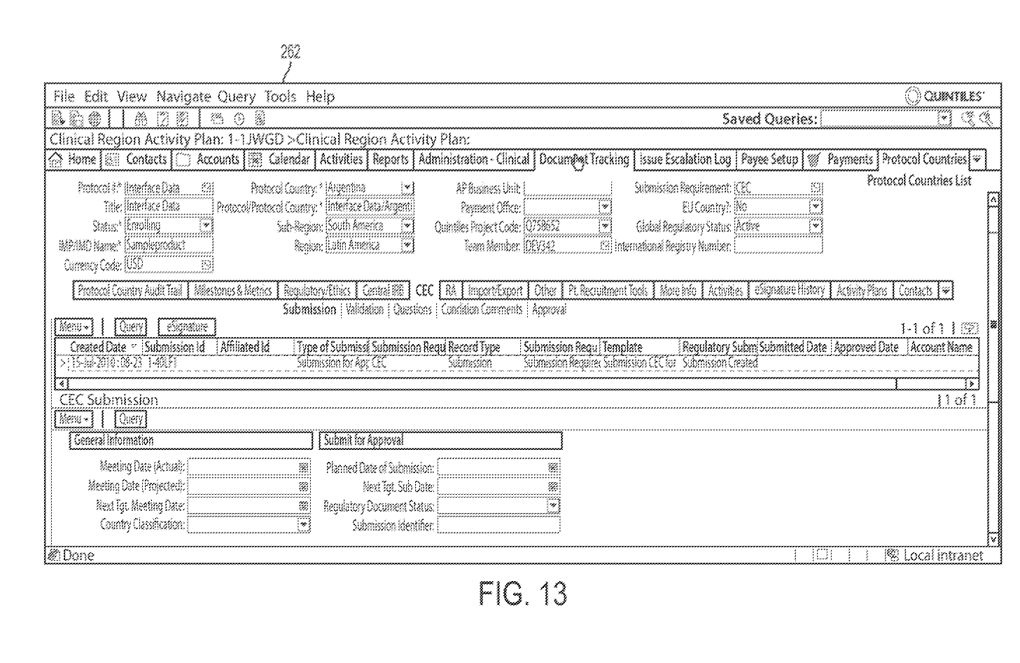

Screen face 262 shown in FIG. 13 shows drill down on information about the CEC submission shown as created in screen face 260 shown in FIG. 12. Toward the bottom of screen face 262, various fields permit entry of meeting dates, planned date of submission, regulatory document status and other information about the CEC submission for Argentina. Other information is shown in FIG. 264 for management and tracking of the clinical trial activities occurring in Argentina for this particular trial; such information includes information about documents which can be stored in documents database 70 and can be accessed by selecting a document identifier in the list, clicking on the identifier, or otherwise linking to the document from screen face 264.

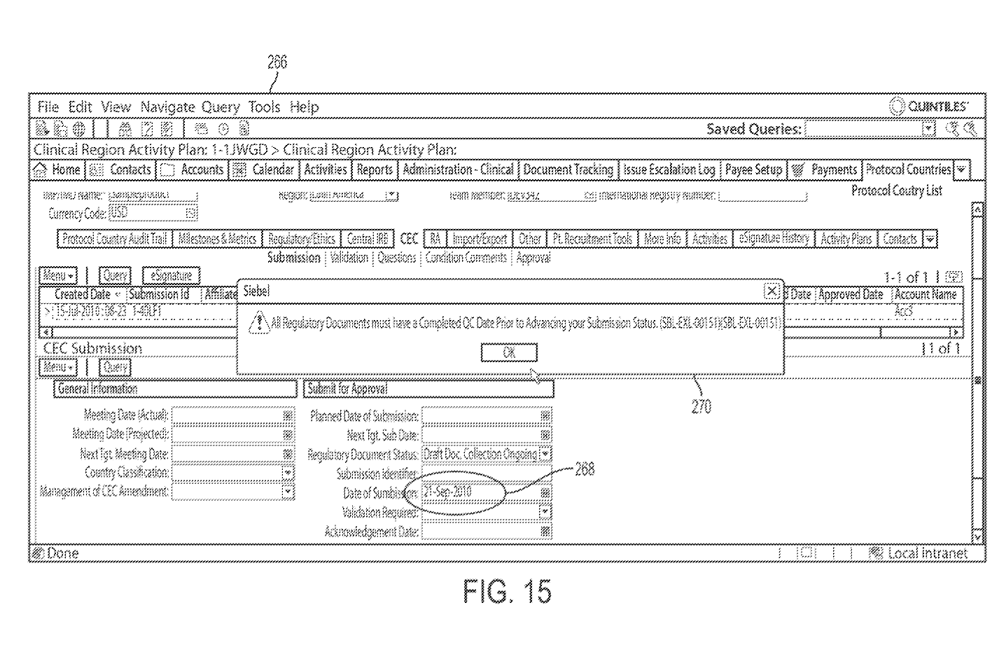

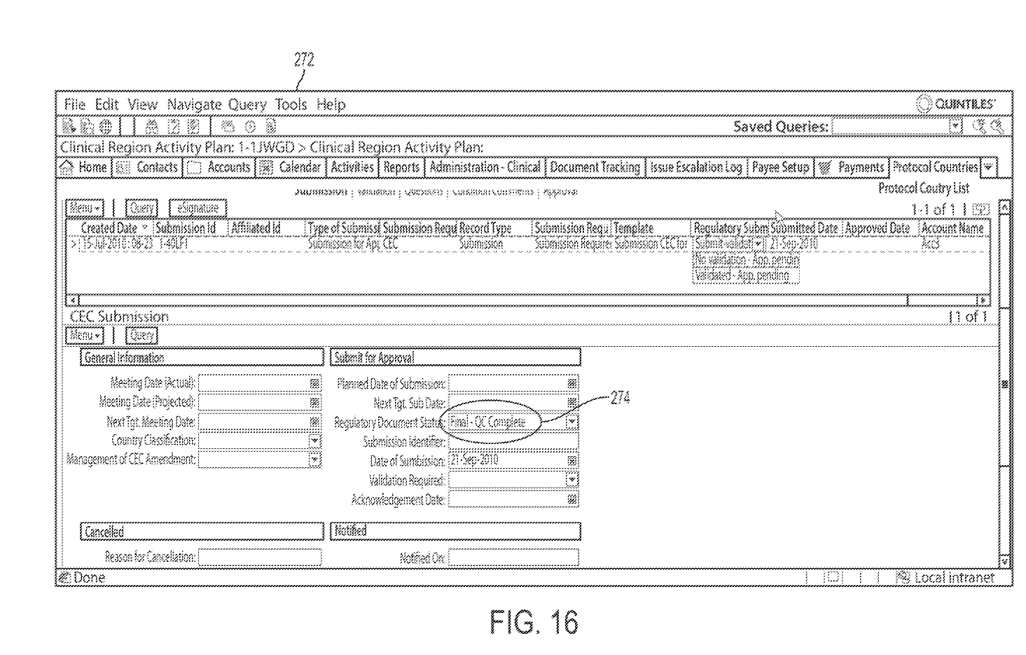

FIG. 15 shows a screen face 266 for tracking the CEC submission in Argentina. When a user attempts to input a submission date as denoted by numeral 268, and predicate steps have not been taken then this predicated activity 268 is not permitted by the system to be the subject of an input. In this case, a pop-up 270 appears which informs the user of predicate activity that has not been completed and entered. Here, the predicate activity is completion of quality control data, which is identified in the pop-up 270 so that the user can complete such activity and enter that completion for tracking in the system as predicate to entry of predicated date of submission entry 268. As shown in screen face 272 in FIG. 16, identification of the predicate activity in pop-up 270 of screen face 266 has allowed the user to deal with the quality control entry issues as denoted by numeral 274 in screen face 272 on FIG. 16, and thus to remove it as an uncompleted predicate activity for entering the predicated submission date in field 268 of screen face 266 shown in FIG. 15.

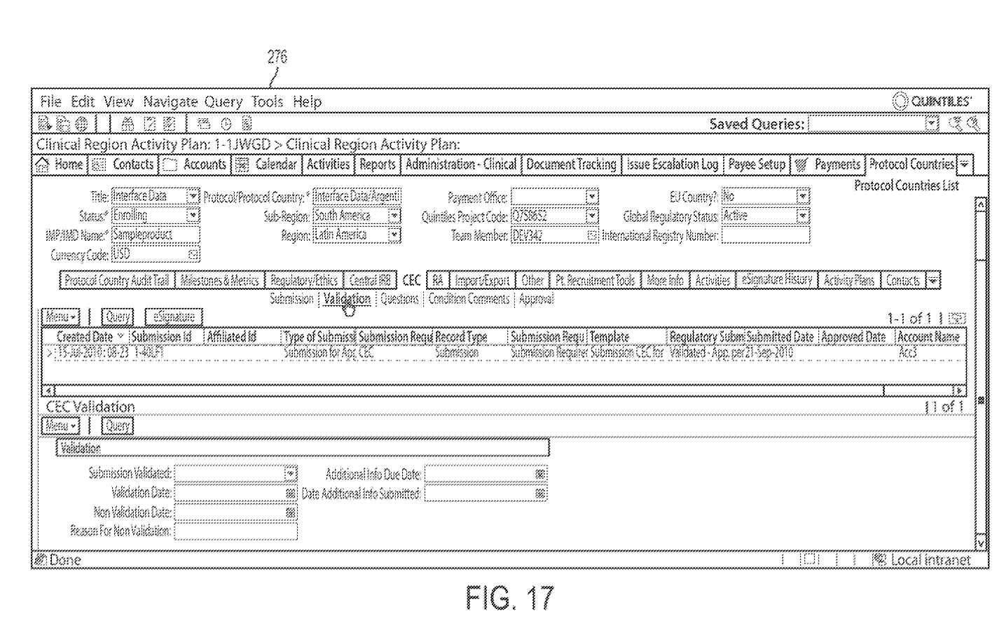

FIG. 17 shows a screen face 276 for managing and tracking validation activities as reflected in, for example, block 90 of FIG. 4. Screen face 276 presents fields that include the same sort of predicate/predicated control of workflow management supported by the system as discussed in connection with FIGS. 15 and 16. Documents in document database 70 are also linked from any or all of screen faces 11-21, including FIG. 17, relating to CEC validation for Argentina.

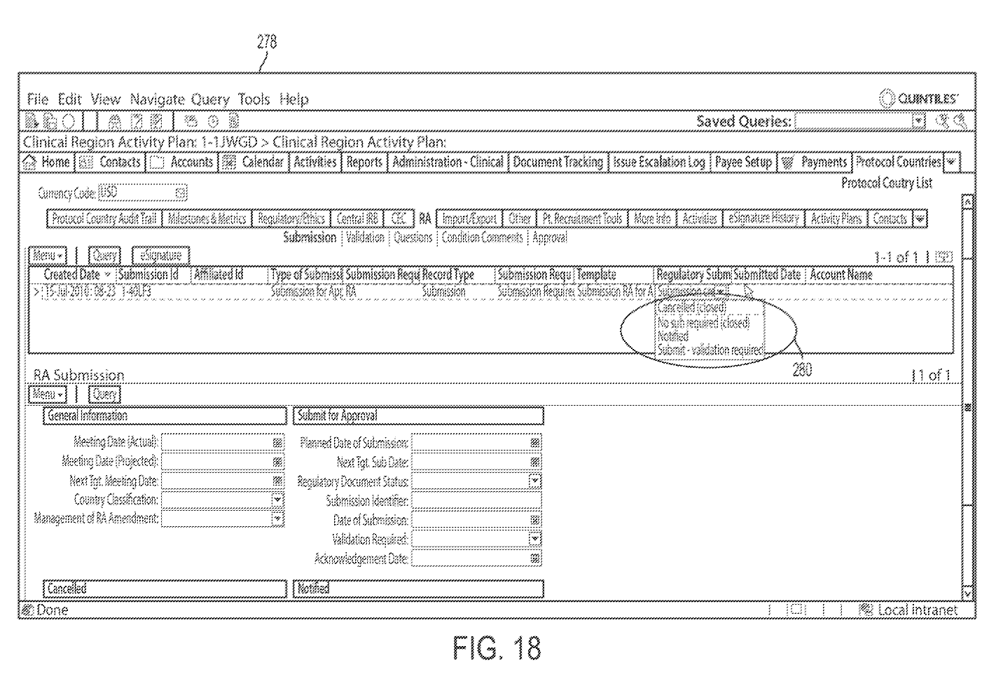

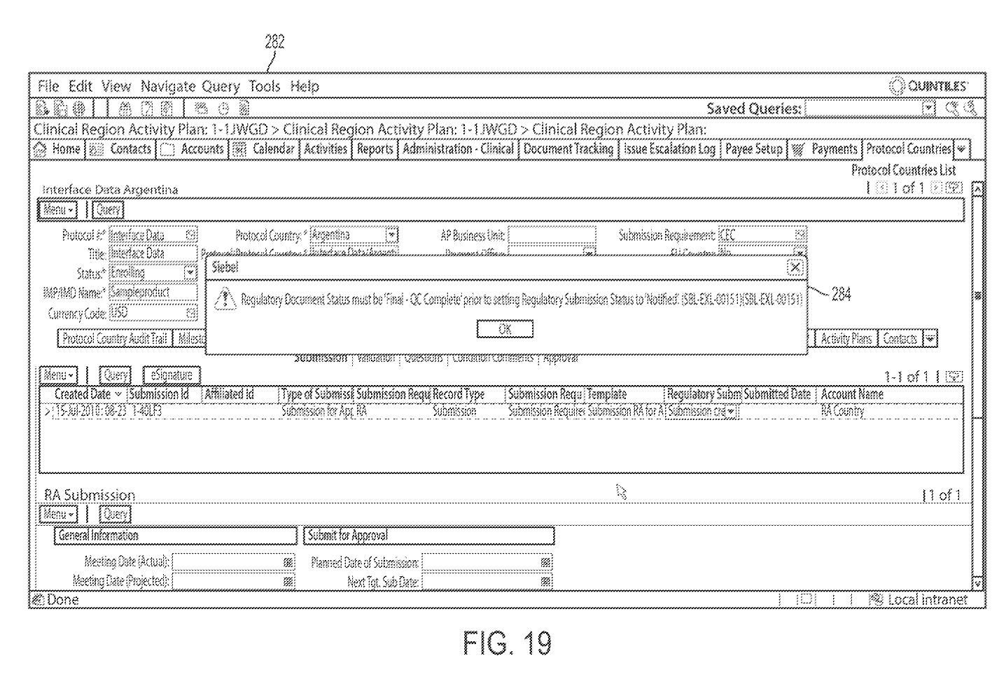

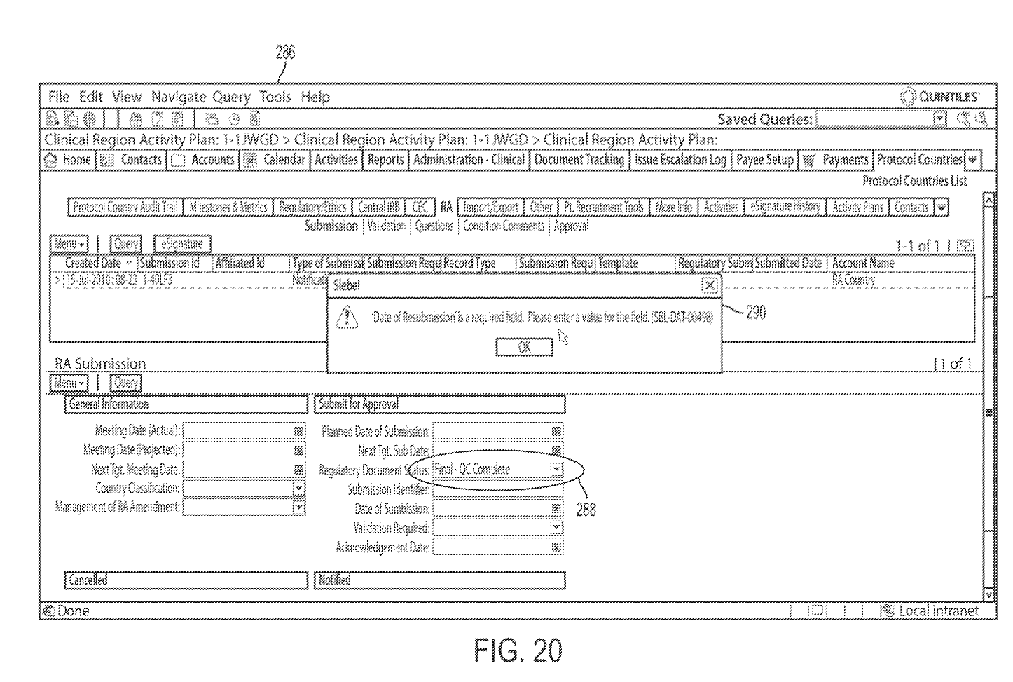

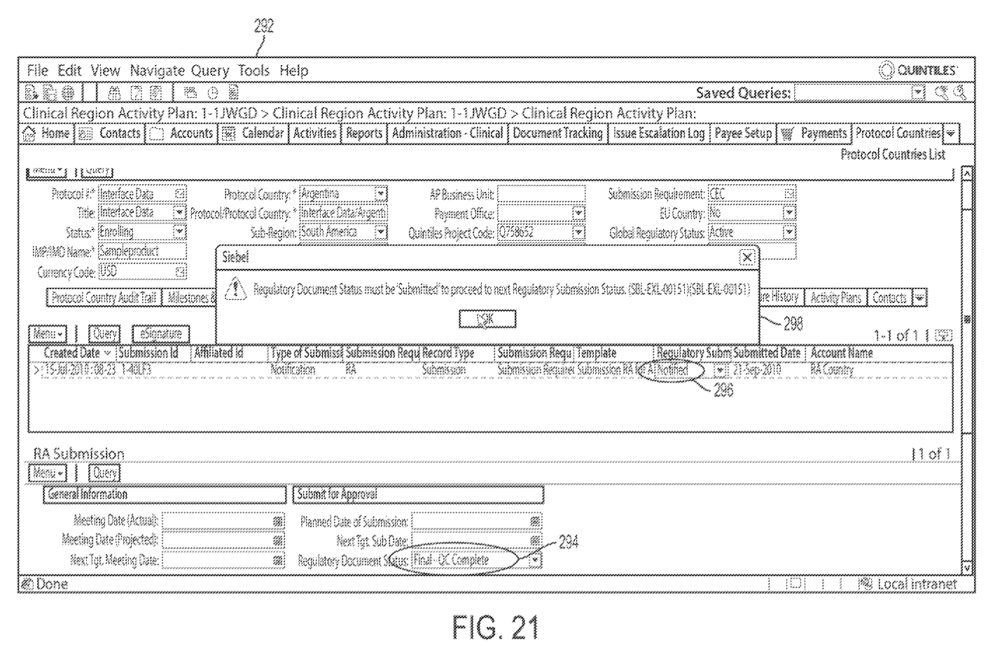

FIGS. 18-21 show another example of predicate/predicated control of clinical trial management as supported by the system, in the context of the Argentina trial and RA submissions in connection therewith. In screen face 278 of FIG. 18, when the user attempts to change the regulatory submission status to “Notified” as denoted by numeral 280, the system determines that the notification status is a predicated step and presents pop-up 284 on screen face 282 as shown in FIG. 19. Pop-up 284 identifies a predicate activity in the form of regulatory document status. Here, that predicate activity is identified as the need to achieve “Final-QC Complete” status before changing status to “Notified” in field 280 of screen face 278 of FIG. 18 is permitted. When the user then attempts to change the regulatory document status to “Final-QC Complete” as denoted by numeral 288 in screen face 286 of FIG. 20, a pop-up 290 appears that identifies another predicate activity in the form of a required field for “Date of Resubmission.” This predicate activity can thus be considered predicate to both the “Final-QC Complete” status shown by numeral 288 of screen face 286 of FIG. 20, and also “Notified” status shown by numeral 280 of screenface 278 of FIG. 18. Accordingly, the system is ensuring, with this predicate/predicated status and activity functionality, that Quality Control and other measures occur in proper sequence in the workflow in order to control submissions to the RA in Argentina in a form that is orderly and increases chances for timely approval. As shown in FIG. 21 on screen face 292, when the regulatory status again is entered as “Notified,” after these predicate activities have been completed and entered, as denoted with numeral 296, a pop-up 298 appears which identifies a follow-on activity in the form of the need to change the regulatory document status to “Submitted” in order to proceed to the next level of workflow, in this case “Regulatory Submission Status.” Accordingly, the user will need to proceed to the Regulatory Document Status field as denoted with numeral 294 to address that activity and any activities predicate and follow-on to it.

Various omissions, modifications, substitutions and changes in the forms and details of the devices, systems, media, and processes illustrated and in their operation can be made by those skilled in the art without departing from the present invention. Accordingly, the scope of the invention is not limited to the foregoing specification, but instead is supplemented by the appended claims and their full range of equivalents and interpretations.

What is claimed is:

1. A system for managing regulatory submissions in a clinical trial, comprising:
(a) A tracking database comprising task tracking data and status indicators for a plurality of tasks; at least some of the tasks arranged according to a predetermined number of workflows, each workflow corresponding to regulatory requirements in a predetermined group of countries and each workflow comprising a succession of tasks, at least one of the tasks constituting a predicated task for which at least one other task is a predicate task that must be completed as a predicate to completion of the predicated task; and
(b) A processing device including a processor capable of executing instructions to:
(i) Receive input comprising identification of a country and identification of a clinical trial;
(ii) Access the tracking database to select and retrieve at least one workflow corresponding to the country, and for the selected at least one workflow, retrieve a plurality of task tracking data and status indicators for a succession of tasks;
(iii) Present information, on at least one presentation interface, about a plurality of tasks in the selected at least one workflow;
(iv) Receive input and update task tracking data and status indicators about at least some of the plurality of tasks in the selected at least one workflow; and
(v) Permit input for a predicated task only when all required tasks that are predicate to the predicated task have been completed.

2. A system according to claim 1, further comprising a document database, the document database comprising a plurality of documents, each document related to at least one of the tasks.

3. A system according to claim 2 wherein at least one of the presentation interfaces includes a reference to at least one document in the document database that corresponds to at least one of the tasks about which information is presented on the presentation interface.

4. A system according to claim 1, wherein the processor is capable of executing instructions to prevent input for a predicated task when at least one status indicator for at least one task that is predicate to the predicated task indicates that the predicate task has not been completed.

5. A system according to claim 4, wherein the processor is capable of executing instructions to present a prompt for at least one predicate task when input for the predicated task is prevented.

6. A system according to claim 1 wherein the tracking database also includes due dates and completion dates for at least some of the tasks.

7. A system according to claim 6 wherein the processor is capable of executing instructions to present a prompt for at least one due date.

8. A system according to claim 1 wherein the tracking database comprises task tracking data and status indicators for tasks arranged according to a predetermined number of regulatory authority workflows, each regulatory authority workflow corresponding to regulatory requirements in a predetermined group of countries.

9. A system according to claim 1 wherein the tracking database comprises task tracking data and status indicators for tasks arranged according to a predetermined number of ethics committee workflows, each ethics committee workflow corresponding to regulatory requirements in a predetermined group of countries.

10. A system according to claim 1 wherein the tracking database comprises task tracking data and status indicators for tasks arranged according to a predetermined number of regulatory authority workflows, each regulatory authority workflow corresponding to regulatory requirements in a predetermined group of countries, and task tracking data and status indicators for tasks arranged according to a predetermined number of ethics committee workflows, each ethics committee workflow corresponding to regulatory requirements in a predetermined group of countries.

11. A system according to claim 1 wherein the predetermined number of workflows comprise a first workflow that includes submission and notification tasks, a second workflow that includes submission, notification, validation, question response and condition fulfillment tasks; a third workflow that includes notification tasks, and a fourth workflow that includes submission, notification and question response tasks.

12. A system according to claim 10 wherein the predetermined number of regulatory authority workflows and the predetermined number of ethics committee workflows each comprise a first workflow that includes submission and notification tasks, a second workflow that includes submission, notification, validation, question response and condition fulfillment tasks; a third workflow that includes notification tasks, and a fourth workflow that includes submission, notification and question response tasks.

13. A system for managing regulatory submissions in a clinical trial, comprising:
(a) A tracking database comprising task tracking data and status indicators for a plurality of tasks;
(i) At least some of the tasks arranged according to a predetermined number of regulatory authority workflows, each regulatory authority workflow corresponding to regulatory requirements in a predetermined group of countries and each regulatory authority workflow comprising a succession of tasks, at least one of the tasks being predicate to a predicated task; and
(ii) At least some of the tasks arranged according to a predetermined number of ethics committee workflows, each ethics committee workflow corresponding to regulatory requirements in a predetermined group of countries and each ethics committee workflow comprising a succession of tasks, at least one of the tasks being predicate to a predicated task;
(b) A document database comprising a plurality of documents, each document related to at least one of the tasks; and
(c) A processing device including a processor capable of executing instructions to:
(i) Receive input comprising identification of a country and identification of a clinical trial;
(ii) Access the tracking database to select and retrieve a selected regulatory authority workflow and a selected ethics committee workflow corresponding to the country, and for each of the selected regulatory authority workflow and the selected ethics committee workflow, retrieve a plurality of task tracking data and status indicators;
(iii) Present information, on at least one presentation interface, about a plurality of tasks in the selected workflow; wherein at least one presentation interface includes a reference to at least one document in the document database that corresponds to at least one of the tasks about which information is presented on the presentation interface;
(iv) Receive input and update task tracking data and status indicators about at least some of the plurality of tasks in the selected workflow;
(v) Permit input for a predicated task only when all required tasks that are predicate to the predicated task have been completed; and
(vi) Prevent input for a predicated task when at least one status indicator for at least one task that is predicate to the predicated task indicates that the predicate task has not been completed.

14. A computer readable storage medium comprising computer executable instructions for managing regulatory submissions in a clinical trial, that when executed by a processor cause the processor to:
(a) Access a tracking database comprising task tracking data and status indicators for a plurality of tasks; at least some of the tasks arranged according to a predetermined number of workflows, each workflow corresponding to regulatory requirements in a predetermined group of countries and each workflow comprising a succession of tasks, at least one of the tasks constituting a predicated task for which at least one other task is a predicate task that must be completed as a predicate to completion of the predicated task;
(b) Receive input comprising identification of a country and identification of a clinical trial;
(c) Select and retrieve from the tracking database at least one workflow corresponding to the country, and for the selected at least one workflow, retrieve a plurality of task tracking data and status indicators for a succession of tasks;
(d) Present information, on at least one presentation interface, about a plurality of tasks in the selected at least one workflow;
(e) Receive input and update task tracking data and status indicators about at least some of the plurality of tasks in the selected at least one workflow; and
(f) Permit input for a predicated task only when all required tasks that are predicate to the predicated task have been completed.

15. A computer readable storage medium according to claim 14 wherein the instructions further cause the processor to access a document database comprising a plurality of documents, each document related to at least one of the tasks.

16. A computer readable storage medium according to claim 15 wherein the instructions further cause the processor to present information on at least one of the presentation interfaces, the information including a reference to at least one document in the document database that corresponds to at least one of the tasks about which information is presented on the presentation interface.

17. A computer readable storage medium according to claim 14 wherein the instructions further cause the processor to prevent input for a predicated task when at least one status indicator for at least one task that is predicate to the predicated task indicates that the predicate task has not been completed.

18. A computer readable storage medium according to claim 17 wherein the instructions further cause the processor to present a prompt for at least one predicate task when input for the predicated task is prevented.

19. A computer readable storage medium according to claim 14 wherein the instructions further cause the processor to access a tracking database that also includes due dates and completion dates for at least some of the tasks.

20. A computer readable storage medium according to claim 19 wherein the instructions further cause the processor to present a prompt for at least one due date.

21. A computer readable storage medium according to claim 14 wherein the instructions further cause the processor to access a tracking database that comprises task tracking data and status indicators for tasks arranged according to a predetermined number of regulatory authority workflows, each regulatory authority workflow corresponding to regulatory requirements in a predetermined group of countries.

22. A computer readable storage medium according to claim 14 wherein the instructions further cause the processor to access a tracking database that comprises task tracking data and status indicators for tasks arranged according to a predetermined number of ethics committee workflows, each ethics committee workflow corresponding to regulatory requirements in a predetermined group of countries.

23. A computer readable storage medium according to claim 14 wherein the instructions further cause the processor to access a tracking database that comprises task tracking data and status indicators for tasks arranged according to a predetermined number of regulatory authority workflows, each regulatory authority workflow corresponding to regulatory requirements in a predetermined group of countries, and task tracking data and status indicators for tasks arranged according to a predetermined number of ethics committee workflows, each ethics committee workflow corresponding to regulatory requirements in a predetermined group of countries.

24. A computer readable storage medium according to claim 14 wherein the instructions further cause the processor to access a tracking database wherein the predetermined number of workflows comprise a first workflow that includes submission and notification tasks, a second workflow that includes submission, notification, validation, question response and condition fulfillment tasks; a third workflow that includes notification tasks, and a fourth workflow that includes submission, notification and question response tasks.

25. A computer readable storage medium according to claim 23 wherein the instructions further cause the processor to access a tracking database wherein the predetermined number of regulatory authority workflows and the predetermined number of ethics committee workflows each comprise a first workflow that includes submission and notification tasks, a second workflow that includes submission, notification, validation, question response and condition fulfillment tasks; a third workflow that includes notification tasks, and a fourth workflow that includes submission, notification and question response tasks.

26. A computer readable storage medium comprising computer executable instructions for managing regulatory submissions in a clinical trial, that when executed by a processor cause the processor to:
(a) Access a tracking database comprising task tracking data and status indicators for a plurality of tasks;
(i) At least some of the tasks arranged according to a predetermined number of regulatory authority workflows, each regulatory authority workflow corresponding to regulatory requirements in a predetermined group of countries and each regulatory authority workflow comprising a succession of tasks, at least one of the tasks being predicate to at least one predicated task; and
(ii) At least some of the tasks arranged according to a predetermined number of ethics committee workflows, each ethics committee workflow corresponding to regulatory requirements in a predetermined group of countries and each ethics committee workflow comprising a succession of tasks, at least one of the tasks being predicate to at least one predicated task;
(b) Access a document database comprising a plurality of documents, each document related to at least one of the tasks; and
(c) Receive input comprising identification of a country and identification of a clinical trial;
(d) Select and retrieve from the tracking database a selected regulatory authority workflow and a selected ethics committee workflow corresponding to the country, and for each of the selected regulatory authority workflow and the selected ethics committee workflow, retrieve a plurality of task tracking data and status indicators;
(e) Present information, on at least one presentation interface, about a plurality of tasks in the selected workflow; wherein at least one presentation interface includes a reference to at least one document in the document database that corresponds to at least one of the tasks about which information is presented on the presentation interface;
(f) Receive input and update task tracking data and status indicators about at least some of the plurality of tasks in the selected workflow;
(g) Permit input for a predicated task when all required tasks that are predicate to the predicated task have been completed; and
(h) Prevent input for a predicated task when at least one status indicator for at least one task that is predicate to the predicated task indicates that the predicate task has not been completed.
